(19) United States
(12) Patent Application Publication
(10) Pub. No.: US 2017/0109835 A1
(43) Pub. Date: Apr. 20, 2017

(54) STANDARD WORKING HOURS MANAGEMENT SYSTEM

(71) Applicants: KANG ZHUN ELECTRONICAL TECHNOLOGY (KUNSHAN) CO., LTD., Kunshan (CN); HON HAI PRECISION INDUSTRY CO., LTD., New Taipei (TW)

(72) Inventor: DIAN-FA JIN, Kunshan (CN)

(21) Appl. No.: 14/928,483

(22) Filed: Oct. 30, 2015

(30) Foreign Application Priority Data
Oct. 15, 2015 (CN) 201510663730.4

(51) Int. Cl. G06Q 40/00

(52) U.S. Cl. CPC G06Q 40/125

(57) ABSTRACT

A standard working hours management system includes at least one microprocessor in an electronic device. The at least one microprocessor processes production line information and standard working hours information and generates a plurality of product reports according to production line information and standard working hours information.

### FIELD

The subject matter herein generally relates to standard working hours management systems, and particularly, to a standard working hours management system used on a production line.

### BACKGROUND

In virtually any production environment, equipment and personnel productivity play an important role in the performance of one or more tasks associated with a project. Equipment and personnel productivity depends, in large part, on the effective management of logistical processes associated with the product environment. These processes generally include scheduling, unit time, line number, daily production time, unit per hours, and so on in order to complete the production.

### BRIEF DESCRIPTION OF THE DRAWINGS

Implementations of the present technology will now be described, by way of example only, with reference to the attached figures.

FIG. 1 is a diagrammatic view of an example embodiment of a standard working hours management system used in an electronic device.

FIG. 2 is a block diagram of an example embodiment of the standard working hours management system and the electronic device of FIG. 1.

FIG. 3 is a diagrammatic view of an example embodiment of the standard working hours management system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like. In general, the word “module”, as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

The present disclosure is described in relation to a standard working hours management system. The standard working hours management system includes at least one microprocessor in an electronic device. The at least one microprocessor processes production line information and standard working hours information and generates a plurality of production reports according to production line information and standard working hours information.

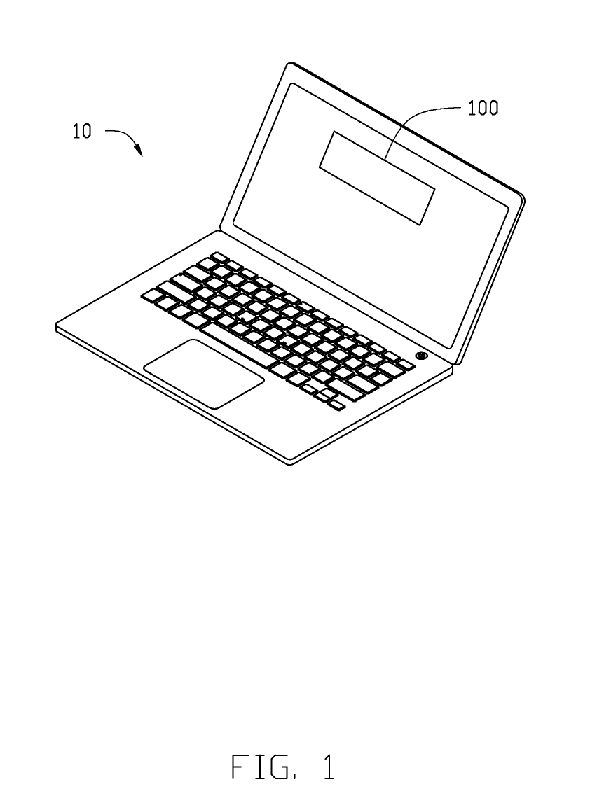

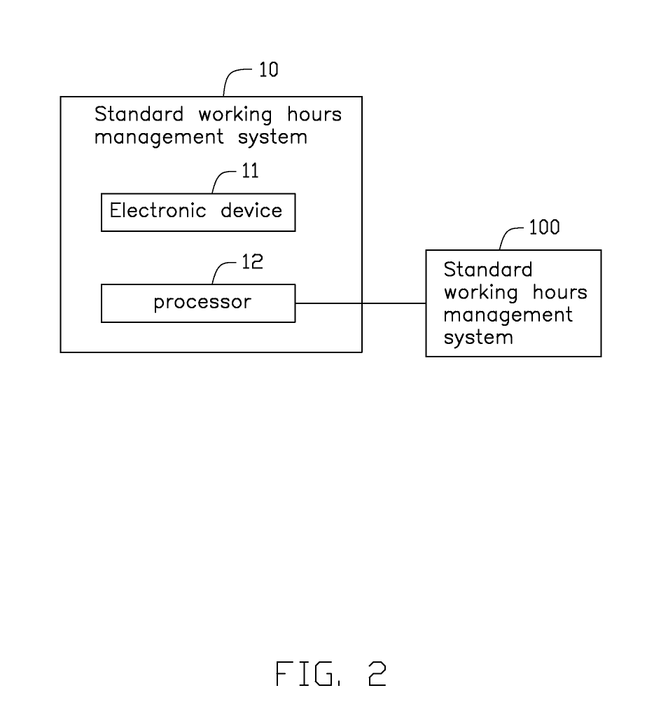

FIGS. 1-2 illustrate an embodiment of a standard working hours management system 100. The standard working hours management system 100 can be used on an electronic device 10 for recording production line information. In at least one embodiment, the electronic device 10 can be a computer, a notebook or a tablet computer.

The electronic device 10 can include at least one processor 11 and a non-transitory storage medium 12. The at least one processor 11 executes one or more computerized codes and other applications of the electronic device 10 to provide functions of the electronic device 10. The non-transitory storage medium 12 stores one or more applications and data of the electronic device 10. In at least one embodiment, the non-transitory storage medium 12 can be an internal non-transitory storage medium, such as a random access memory (RAM) for temporary storage of information, and/or a read only memory (ROM) for permanent storage of information. The non-transitory storage medium 12 can also be an external non-transitory storage medium, such as an external hard disk, a storage card, or a data storage medium.

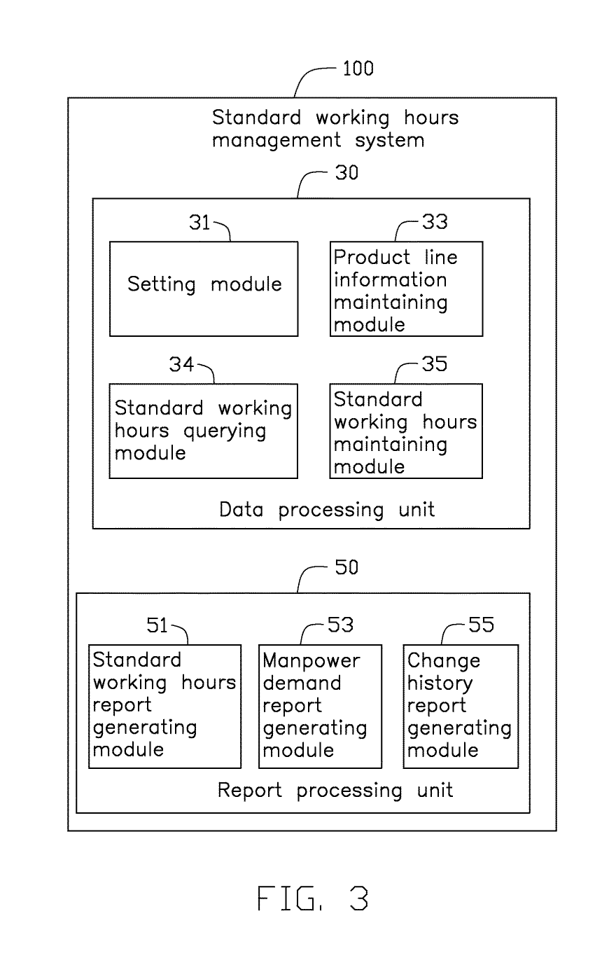

In at least one embodiment, the standard working hours management system 100 can include, but is not limited to, a data processing unit 30 and a report processing unit 50, as shown in FIG. 3. In at least one embodiment, the data processing unit 30 can include, but is not limit to, a setting module 31, a production line information maintaining module 33, a standard working hours querying module 34, and a standard working hours maintaining module 35. The report processing unit 50 can include, but is not limit to, a standard working hours report generating module 51, a manpower demand report generating module 53, and a change in history report generating module 55. The modules 31, 33, 34, 35, 51, 53 and 55 can include computerized instructions in the form of one or more computer-readable programs that can be stored in a non-transitory computer-readable medium, such as the non-transitory storage medium 12, and be executed by the at least one processor 11 of the electronic device 10. A description of each module of the standard working hours management system 100 is given in the following paragraphs.

The setting module 31 is configured to set the user authorization, that is, a permitted user can be enter into the standard working hours management system 100.

The production line information maintaining module 33 is configured to process production line information. For example, the process line information can include, but is not limit to, a production line number, a process category, a stand number, a machine configuration parameters. The production line information maintaining module 33 can be configured to add, modify or delete the process line information. In at least one embodiment, the production line information can be bulk imported as an Excel file.

The standard working hours querying module 34 can be configured to query the production line information. When the production line information needs to display on the electronic device 10, the production line number can be triggered, and the production line information, including the production line number, the process category, the stand number, the machine configuration parameters, the daily production time, the timesheet number, can be shown on the electronic device 10.

The standard working hours maintaining module 35 is configured to process standard working hours information. For example, the standard working hours information can include, but is not limit to, a peak time, a daily production time, a timesheet number, and a balance rate. The standard working hours maintaining module 35 can be configured to add, modify or delete the standard working hours information. In at least one embodiment, the standard working hours information can be bulk imported as an Excel file.

The standard working hours report generating module 51 is configured to generate a standard working hours report, and the standard working hours report can include the production line information and the standard working hours information.

The manpower demand report generating module 53 is configured to generate a manpower demand report, and the manpower demand report can include, but not limit to, an online user count, an offline user count, and a total user in count.

The change in history report generating module 55 is configured to a generate change in history report, and the change in history report can include a change in history that adding, modifying or deleting the production line information and the standard working hours information.

The embodiments shown and described above are only examples. Many details are often found in the art such as the other features of a standard working hours management system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A standard working hours management system comprising:
an electronic device comprising:
at least one processor;
a non-transitory storage medium coupled to the at least one processor and configured to store instructions to cause the electronic device to:
process a production line information and a standard working hours information; and
generate a plurality of product reports according to a production line information and a standard working hours information.

2. The standard working hours management system of claim 1, wherein the at least one microprocessor is also configured to set a user authorization.

3. The standard working hours management system of claim 1, wherein the standard working hours information comprises a peak time, a daily production time, a timesheet number, and a balance rate.

4. The standard working hours management system of claim 1, wherein the process line information comprises a production line number, a process category, a stand number, a machine configuration parameters.

5. The standard working hours management system of claim 1, wherein the plurality of product reports comprises a standard working hours report, and the standard working hours report comprises the production line information and the standard working hours information.

6. The standard working hours management system of claim 1, wherein the plurality of product reports comprises a manpower demand report, and the manpower demand report comprises an online human count, an offline human count, and a total human count.

7. The standard working hours management system of claim 1, wherein the plurality of product reports comprises a change history report, and the change history report comprises a change history that adding, modifying or deleting the production line information and the standard working hours information.

8. A standard working hours management system comprising:
a non-transitory storage medium configured to store instructions of an electronic device.
at least one microprocessor in the electronic device to be coupled to the non-transitory storage medium and being configured to:
sett a user authorization for entering into standard working hours management system;
process a production line information and a standard working hours information; and
generate a plurality of product reports according to the a production line information and a standard working hours information.

9. The standard working hours management system of claim 8, wherein the standard working hours information comprises a peak time, a daily production time, a timesheet number, and a balance rate.

10. The standard working hours management system of claim 8, wherein the process line information comprises a production line number, a process category, a stand number, a machine configuration parameters.

11. The standard working hours management system of claim 8, wherein the plurality of product reports comprises a standard working hours report, and the standard working hours report comprises the production line information and the standard working hours information.

12. The standard working hours management system of claim 8, wherein the plurality of product reports comprises a manpower demand report, and the manpower demand report comprises an online human count, an offline human count, and a total human count.

13. The standard working hours management system of claim 8, wherein the plurality of product reports comprises a change history report, and the change history report comprises a change history that adding, modifying or deleting the production line information and the standard working hours information.
